(19) United States
(12) Patent Application Publication
(10) Pub. No.: US 2024/0420414 A1
(43) Pub. Date: Dec. 19, 2024

(54) LIGHTING OF 3-DIMENSIONAL MODELS IN AUGMENTED REALITY

(71) Applicant: Walmart Apollo, LLC, Bentonville, AR (US)

(72) Inventors: Daniel Hyunwoo Lee, Whittier, CA (US); Sreeneel Maddika, San Ramon, CA (US); Vijay Saradhi Yellapragada, San Ramon, CA (US)

(73) Assignee: Walmart Apollo, LLC, Bentonville, AR (US)

(21) Appl. No.: 18/209,769

(22) Filed: Jun. 14, 2023

(51) Int. Cl. G06T 15/50; G06T 19/00

(52) U.S. Cl. CPC G06T 15/506; G06T 19/006

(57) ABSTRACT

A system including one or more processors and one or more non-transitory computer-readable media storing computing instructions, that when executed on the one or more processors, cause the one or more processors to perform operations including: determining a view mode in which to render a 3-dimensional (3D) model of an item on an electronic device based on a selection by a user; when the view mode is a stand-alone 3D model view, positioning a virtual light in a fixed position with respect to the 3D model of the item while a camera of a user device moves around the 3D model of the item; and when the view mode is an augmented reality (AR) environment, projecting the virtual light outward from a position of a lens of the camera to allow the virtual light to move as the camera moves with respect to the 3D model of the item. Other embodiments are disclosed.

### TECHNICAL FIELD

This disclosure relates generally relates to lighting of 3-dimensional models in augmented reality.

### BACKGROUND

Due to the lack of natural light sources in a digital space, a 3-dimensional model viewed in an augmented reality space can appear darker and unrealistic.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for lighting a 3-dimensional model as rendered in multiple view modes, according to an embodiment;

FIG. 4 illustrates a flow chart for a method, according to another embodiment;

FIG. 5 illustrates an example of a 3D model of an item being viewed on an interactive user interface; and

FIG. 6 illustrates an example of how a virtual light can be used to simulate natural light.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 1 millisecond, 10 milliseconds, 1 second, 10 seconds, or another suitable time delay period.

### DESCRIPTION OF EXAMPLES OF EMBODIMENTS

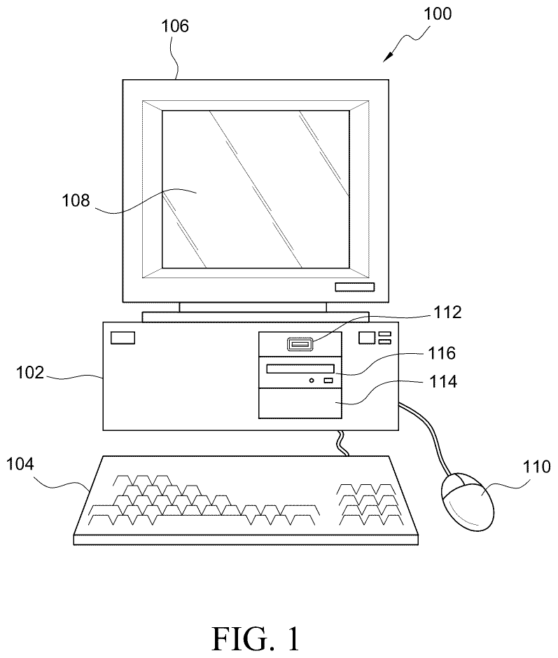

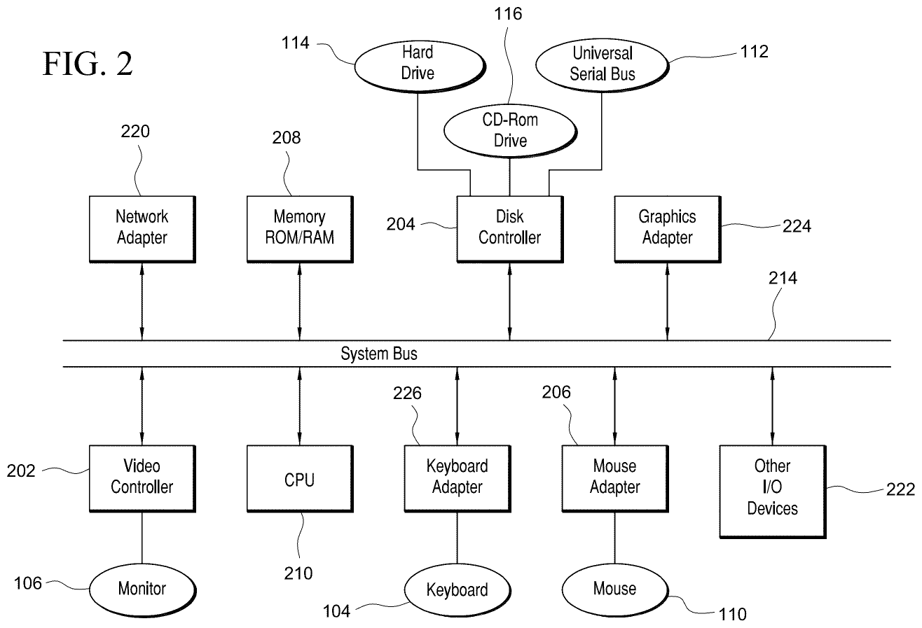

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

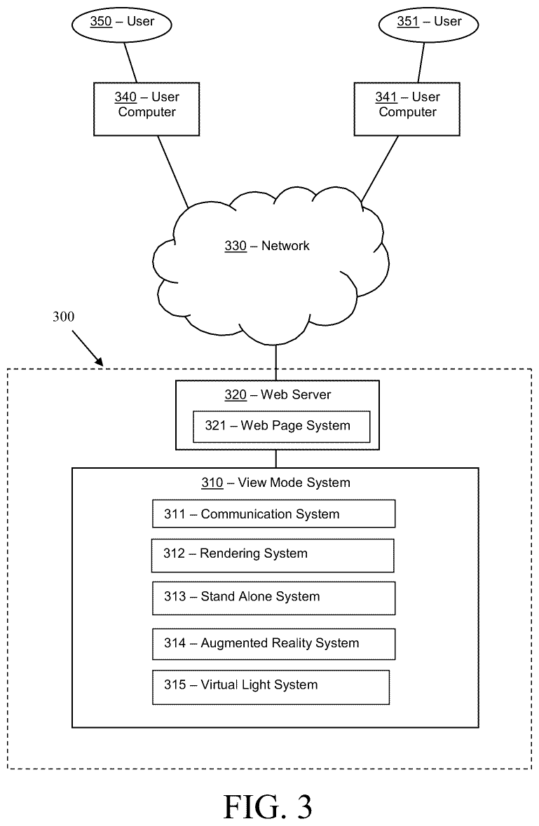

Turning ahead in the drawings, FIG. 3 illustrates a block diagram of a system 300 that can be employed for a lighting a 3-dimensional model as rendered in multiple view modes, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a view mode system 310 and/or a web server 320. View mode system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, view mode system 310 and/or web server 320. Additional details regarding view mode system 310 and/or web server 320 are described herein.

In a number of embodiments, view mode system 310 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allows users to view and/or rotate a 3-dimensonal (3D) model of an item (e.g., object) in a 3D virtual space or an augmented reality (AR) scene, to browse and/or search for items (e.g., products), to add items to an electronic shopping cart, and/or to order (e.g., purchase) items, in addition to other suitable activities.

In some embodiments, an internal network that is not open to the public can be used for communications between view mode system 310 and/or web server 320 within system 300. Accordingly, in some embodiments, view mode system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Meanwhile, in many embodiments, system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, view mode system 310 can include a communication system 311, a rendering system 312, a stand-alone system 313, an augmented reality system 314, and/or a virtual light system 315. In many embodiments, the systems of view mode system 310 can be modules of computing instructions (e.g., software modules) stored at non-transitory computer readable media that operate on one or more processors. In other embodiments, the systems of view mode system 310 can be implemented in hardware. View mode system 310 can be a computer system, such as computer system 100 (FIG. 1), as described above, and can be a single computer, a single server, or a cluster or collection of computers or servers, or a cloud of computers or servers. In another embodiment, a single computer system can host view mode system 310. Additional details regarding view mode system 310 and the components thereof are described herein.

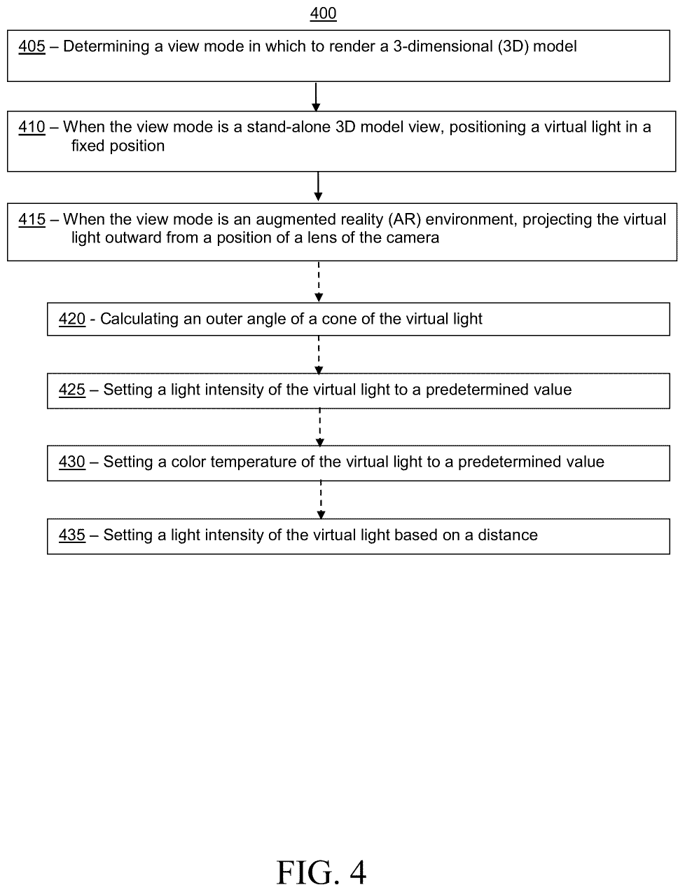

Turning ahead in the drawings, FIG. 4 illustrates a flow chart for a method 400, according to another embodiment. In some embodiments, method 400 can be a method of simulating natural light levels on a 3D model of an item viewed in a virtual space. Method 400 is merely exemplary and is not limited to the embodiments presented herein. Method 400 can be employed in many different embodiments and/or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as view mode system 310 and/or web server 320. The processor(s) can be similar or identical to the processor(s) described above with respect to computer system 100 (FIG. 1).

Referring to FIG. 4, method 400 can include an activity 405 of determining a view mode in which to render a 3-dimensional (3D) model of an item on an electronic device based on a selection by a user. In various embodiments, a view mode can include viewing the 3D model in multiple virtual scenes or digital environments. In several embodiments, the virtual light can be generated for use in either view mode. In several embodiments, a user can interact with a user interface on the electronic device and select a view mode to view the item. In various embodiments, the user can switch back and forth to different view modes by digitally manipulating the icons on the user interface so as to view the 3D model as a stand-alone model view or in multiple AR environments. In several embodiments, the user can view both modes on a split screen in real-time to compare the stand-alone model view in multiple view modes, such as two different AR environments in parallel.

In some embodiments, generating the virtual light can include calculating a custom virtual spotlight for each respective 3D model of the item, prior to launching a view mode for rendering 3D models. In various embodiments, customizing the virtual spotlight for each view mode can begin with calculating a radius of an outer most circle of a cone of the light hitting a surface based on the base dimension of the 3D model, where the radius=double of the largest side of the base of the cone=max (model dimension x, model dimension z)*2. In some embodiments, customizing the virtual spotlight for each respective 3D model can include calculating a distance away from the 3D model to determine optimal lighting conditions for each respective 3D model. In several embodiments, calculating the distance away from the 3D model can include using variables such as the radius of the cone, an approximate volume of the cone, and the height of the cone, where the radius and the approximate volume of the virtual spotlight cone can be used for calculating the height of the cone for the virtual spotlight generated for each respective 3D model. In some embodiments, an approximate volume can include 75.4 m³ and the height of the virtual spotlight cone can include an average of 8 m. In a number of embodiments, setting the intensity of the spotlight and color temperature of the spotlight can be hard coded to default ranges can be similar or identical to the activities describe below in connection with activities 420, 425, 430, and 435.

In several embodiments, rendering or synthesizing the 3D model of an item can begin with using a processor to interpret data sent from an image sensor and translating the data into a realistic image. In some embodiments, an image sensor can scan a 2-dimensional (2D) image from a catalog (e.g., online catalog) and translate the data into a 3D model of the item then saving the 3D model in a database. In some embodiments, the translated rendering of the 3D model can be transformed into a computer generated image configured to be viewed and manipulated in multiple virtual or digital environments, such as a virtual scene or an augmented reality environment.

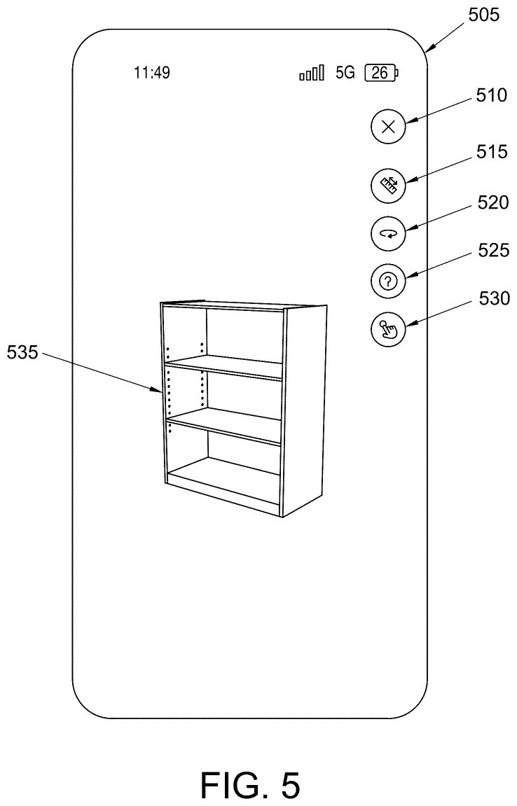

Conventionally, when viewing 3D models in a virtual scene, due to the lack of natural light sources in the scene, the 3D models can appear darker taking on an unrealistic visual perspective. One advantage of generating a custom virtual spotlight is to simulate a natural lighting source pointing at the 3D model at a distance from the model with the outer cone angle of the spotlight corresponding to a radius of a bounding box on the model so that the 3D model as lighted is viewed as a realistic item similar to viewing the item in a showroom with studio lighting. In some embodiments, a bounding box can refer to a width, a height, and depth dimensions of a 3D model that can be used to determine a radius of the cone. In many embodiments, the radius can be determined by the largest base side depending on the anchoring orientation of the 3D model being viewed in either in a horizontal plane or a vertical plane, which can include using either (i) the width or depth for horizontally anchored items or (ii) the width or height for vertically anchored items. A technical advantage of implementing a custom virtual spotlight for each respective 3D model is that the custom virtual spotlight is further designed to individually follow the 3D model as the 3D model is manipulated in multiple viewing angles of a 360 degree movement displayed on a user interface, such as described in additional detail in connection with FIG. 5, below.

In several embodiments, when the view mode is a stand-alone 3D model view, method 400 also can include an activity 410 of positioning a virtual light in a fixed position with respect to the 3D model of the item while a camera of a user device moves around the 3D model of the item. In various embodiments, the virtual light can include a virtual spotlight. In some embodiments, the stand-alone 3D model view can include a virtual space with a white background where the 3D model is placed within the center point unencumbered by a virtual scene or AR environment so as to view the 3D model in isolation.

In various embodiments, to achieve a smooth orbiting (e.g., arcball) perspective when the camera moves around the 3D model, a user interface can be configured with a scrolling function. In a number of embodiments, the scrolling function can be configured to translate the content of the 3D model from the screen of the user interface to multiple spherical coordinates to allow the user to control each position of the camera and each respective direction of the camera to view the 3D model in multiple angles and perspectives in the virtual scene (e.g., digital space). Such a user interface function can include a user interface scroll viewer (UIScrollView) application. In some embodiments, by enlarging a default scroll view content size to be three times the width and two times the height of a screen size of an electronic device in pixels, where the user interface can apply effects to the interface function include a built-in inertia, bouncing, and rubber-banding animation using dynamic positioning of the camera. Such an electronic device can include a mobile electronic device.

An advantage to using dynamic positioning of the camera can include a smooth interaction between digital interactions (e.g., finger gestures) on an interactive user interface screen and manipulating camera positioning around the 3D model in a virtual scene or an AR environment. FIG. 5 illustrates an example of a 3D model 535 of an item being viewed on an interactive user interface on the electronic device. In many cases, the item can be selected from a catalog, such as a bookcase. In some embodiments, 3D model 535 can be viewed on a user interface 505 with examples of interactive icons 510-530 available on the user interface 505, wherein the user can digitally manipulate 3D model 535 on the screen and/or change the viewing perspective using the interactive icons. Such interactive icons can be selected to manipulate a camera around 3D model 535 based on an anchoring orientation so as to view the items in various rotational degrees from 0 to a full 360 degrees of an arc rotation in a virtual or digital space. In many embodiments, the anchoring orientation of 3D model 535 can refer to how 3D model 535 is anchored in a virtual environment, such as the stand-alone 3D model view and/or the AR environment.

In some embodiments, activity 410 of positioning the virtual light positioning the virtual light in the fixed position above the 3D model of the item and directed toward the 3D model of the item. In various embodiments, the virtual light can be positioned directly on top of the 3D model when the anchoring position of the item is displayed in the user interface on a horizontal plane to maintain shadows that are visible in the horizontal plane mimicking how the item is viewed in real life. As an example, a piece of furniture such as a bookcase or a sofa can be displayed on the horizontal plane to allow the camera to move around the 3D model.

In many embodiments, activity 410 of positioning the virtual light can further include positioning the virtual light in the fixed position in front of the 3D model of the item to direct the virtual light toward the 3D model of the item when the item is designed to be attached to a vertical surface. In some embodiments, the virtual light can be positioned in front of the 3D model of the item when the anchoring position of the item is displayed in the user interface on a vertical plane mimicking how the item is viewed in real life. As an example, a poster or picture frame can be displayed affixed to a wall on a vertical plane to also allow the camera to move around the 3D model.

In some embodiments, activity 410 of positioning the virtual light can also include generating an invisible horizontal surface located under the 3D model of the item when the item is placed on a horizontal surface to prevent rendering shadows projected by the virtual light on the horizontal surface. In several embodiments, in addition to the virtual light, the invisible horizontal surface can include generating an occluding invisible plane underneath the 3D model in the virtual scene.

In various embodiments, when the view mode is an augmented reality (AR) environment, method 400 additionally can include activity 415 of projecting a directional light outward from a position of a lens of the camera to allow the virtual light to move as the camera moves with respect to the 3D model of the item. In various embodiments, the virtual light can include a directional light. In several embodiments, an advantage of projecting the directional light outward from the position of the camera lens includes casting light uniformly on multiple numbers of meshes in the AR environment along a direction from the camera lens where light follows the camera. In a number of embodiments, the light intensity can be set to a predetermined value of 1,000 lumens for vertical items and 2,000 lumens for horizontal items. In some embodiments, directional light is anchored and/or attached to the camera lens so that as the camera moves the light moves as well. In many embodiments, activity 415 can use predetermined lumen values for the AR environment to simulate a studio-like environment with more exposed lighting conditions as the AR environment can be well-lit from natural conditions.

In some embodiments, method 400 can optionally and alternatively include an activity 420 of calculating an outer angle of a cone of the virtual spotlight. In various embodiments, calculating the outer angle of the cone to attenuate the light intensity between 0 inner degrees and a resulting outer angle (ex. approximately 15-30 degrees) can include using an A tan (radius/height) function expressed as:

Outer Angle=A tan(r/h)

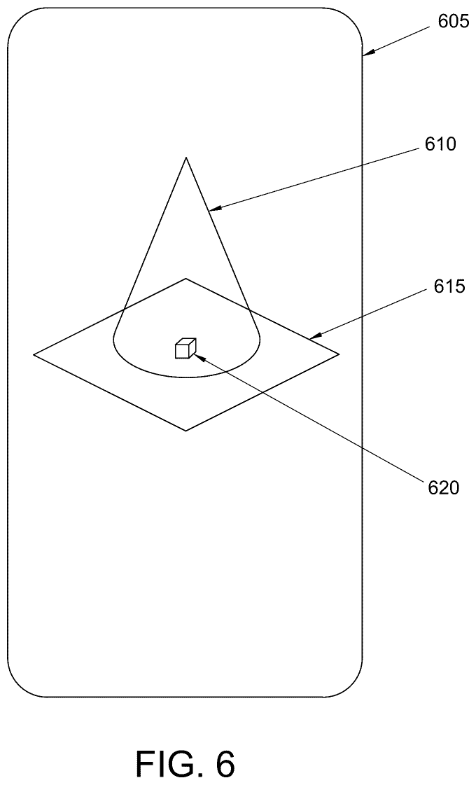

FIG. 6 illustrates an example of how a virtual light can be used to simulate natural light on a 3D model when viewed in a virtual space on a user interface 605. In this example, a cone 610 of light pointing to a 3D model 620, where 3D model 620 is centered on top of a invisible horizontal surface 615 (e.g., an occluding invisible plane) underneath 3D model 620.

In many embodiments, activity 420 further can include determining a light intensity attenuated between zero degrees and the outer angle of the cone of the virtual light. In several embodiments, the virtual light can include a virtual spotlight. In various embodiments, setting the inner angle of the cone to zero degrees can be advantageous as the spotlight (e.g., virtual light) intensity is the strongest in the center of the cone.

In a number of embodiments, method 400 can optionally and alternatively include an activity 425 of setting a light intensity of the virtual light to a predetermined value. In some embodiments, the predetermined value can be approximately 33,700 lumens to simulate the natural light intensity when directed on the 3D model.

In several embodiments, method 400 can optionally and alternatively include an activity 430 of setting a color temperature of the virtual light to a predetermined value. In various embodiments, the predetermined value for the color temperature can be hardcoded to white.

In some embodiments, method 400 can optionally and alternatively include an activity 435 of setting a light intensity of the virtual light based on a distance of the virtual light from the 3D model of the item. In several embodiments, setting the light intensity of the virtual light can include setting a stronger light intensity the further away the light is from the 3D model. An advantage to positioning a respective light further away from each 3D model using a higher light intensity based on the distance allows each 3D model to appear well-lit without looking to exposed to light as 3D models can be more reflective than 2D models.

Returning to FIG. 3, in several embodiments, communications system 311 can at least partially perform activity 405 of determining a view mode in which to render a 3-dimensional (3D) model of an item on an electronic device based on a selection by a user.

In some embodiments, rendering system 312 can at least partially perform activity 435 of setting a light intensity of the virtual light based on a distance of the virtual light from the 3D model of the item.

In various embodiments, stand-alone system 313 can at least partially perform when the view mode is a stand-alone 3D model view, activity 410 of positioning the virtual light can additionally include positioning the virtual light in the fixed position above the 3D model of the item and directed toward the 3D model of the item.

In a number of embodiments, augmented reality system 314 can at least partially perform when the view mode is an augmented reality (AR) environment, method 400 additionally can include activity 415 of projecting the virtual light outward from a position of a lens of the camera to allow the virtual light to move as the camera moves with respect to the 3D model of the item.

In several embodiments, virtual light system 315 can at least partially perform activity 425 of setting a light intensity of the virtual light to a predetermined value; activity 430 of setting a color temperature of the virtual light to a predetermined value.

In several embodiments, web server 320 can include a webpage system 321. Webpage system 321 can at least partially perform sending instructions to user computers (e.g., 350-351 (FIG. 3)) based on information received from communication system 311.

In many embodiments, the techniques described herein can be used continuously at a scale that cannot be handled using manual techniques. For example, the number of daily and/or monthly visits to the content source can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as viewing a 3D model using an interactive user interface in a stand-alone 3D model view or an AR environment does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because a content catalog, such as an online catalog, that can power and/or feed an online website that is part of the techniques described herein would not exist.

Various embodiments can include a system. A system can include one or more processors and one or more non-transitory computer-readable media storing computing instructions, that when executed on the one or more processors, cause the one or more processors to perform certain acts. The acts can include determining a view mode in which to render a 3-dimensional (3D) model of an item on an electronic device based on a selection by a user. When the view mode is a stand-alone 3D model view, the acts also can include positioning a virtual light in a fixed position with respect to the 3D model of the item while a camera of a user device moves around the 3D model of the item. When the view mode is an augmented reality (AR) environment, the acts further can include projecting the virtual light outward from a position of a lens of the camera to allow the virtual light to move as the camera moves with respect to the 3D model of the item.

A number of embodiments can include a method. A method being implemented via execution of computing instructions configured to run at one or more processors and stored at one or more non-transitory computer-readable media. The method can include determining a view mode in which to render a 3-dimensional (3D) model of an item on an electronic device based on a selection by a user. When the view mode is a stand-alone 3D model view, the method also can include positioning a virtual light in a fixed position with respect to the 3D model of the item while a camera of a user device moves around the 3D model of the item. When the view mode is an augmented reality (AR) environment, the method further can include projecting the virtual light outward from a position of a lens of the camera to allow the virtual light to move as the camera moves with respect to the 3D model of the item.

Although determining a view mode in which to render a 3D model of an item in an electronic device based on a user selection has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIGS. 3-4 may include different procedures, processes, and/or activities and be performed by many different modules, in many different orders, and/or one or more of the procedures, processes, or activities of FIGS. 3-4 may include one or more of the procedures, processes, or activities of another different one of FIGS. 3-4. Various elements of FIGS. 3-6 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions, that when executed on the one or more processors, cause the one or more processors to perform operations comprising:
determining a view mode in which to render a 3-dimensional (3D) model of an item on an electronic device based on a selection by a user;
when the view mode is a stand-alone 3D model view, positioning a virtual light in a fixed position with respect to the 3D model of the item while a camera of a user device moves around the 3D model of the item; and
when the view mode is an augmented reality (AR) environment, projecting the virtual light outward from a position of a lens of the camera to allow the virtual light to move as the camera moves with respect to the 3D model of the item.

2. The system of claim 1, wherein when the view mode is the stand-alone 3D model view, positioning the virtual light further comprises:
positioning the virtual light in the fixed position above the 3D model of the item and directed toward the 3D model of the item, wherein the virtual light comprises a virtual spotlight.

3. The system of claim 1, wherein when the view mode is the stand-alone 3D model view, positioning the virtual light further comprises:
positioning the virtual light in the fixed position in front of the 3D model of the item to direct the virtual light toward the 3D model of the item when the item is designed to be attached to a vertical surface, wherein the virtual light comprises a virtual spotlight.

4. The system of claim 1, wherein when the view mode is stand-alone 3D model view, positioning the virtual light further comprises:
generating an invisible horizontal surface located under the 3D model of the item when the item is placed on a horizontal surface to prevent rendering shadows projected by the virtual light on the horizontal surface, wherein the virtual light comprises a virtual spotlight.

5. The system of claim 1 wherein the computing instructions, when executed on the one or more processors, further cause the one or more processors to perform an operation comprising:
calculating an outer angle of a cone of the virtual light, wherein the virtual light comprises a virtual spotlight.

6. The system of claim 5, wherein calculating the outer angle of the cone of the virtual light comprises:
determining a light intensity attenuated between zero degrees and the outer angle of the cone of the virtual spotlight.

7. The system of claim 1 wherein the computing instructions, when executed on the one or more processors, further cause the one or more processors to perform an operation comprising:
setting a light intensity of the virtual light to a predetermined value.

8. The system of claim 1 wherein the computing instructions, when executed on the one or more processors, further cause the one or more processors to perform an operation comprising:
setting a color temperature of the virtual light to a predetermined value.

9. The system of claim 1 wherein the computing instructions, when executed on the one or more processors, further cause the one or more processors to perform an operation comprising:
setting a light intensity of the virtual light based on a distance of the virtual light from the 3D model of the item.

10. The system of claim 1 wherein the computing instructions, when executed on the one or more processors, further cause the one or more processors to perform operations comprising:
setting a light intensity of the virtual light to a first predetermined value; and
setting a color temperature of the virtual light to a second predetermined value.

11. A method being implemented via execution of computing instructions configured to run on one or more processors and stored at one or more non-transitory computer-readable media, the method comprising:
determining a view mode in which to render a 3-dimensional (3D) model of an item on an electronic device based on a selection by a user;
when the view mode is a stand-alone 3D model view, positioning a virtual light in a fixed position with respect to the 3D model of the item while a camera of a user device moves around the 3D model of the item; and
when the view mode is an augmented reality (AR) environment, projecting the virtual light outward from a position of a lens of the camera to allow the virtual light to move as the camera moves with respect to the 3D model of the item.

12. The method of claim 11, wherein when the view mode is the stand-alone 3D model view, positioning the virtual light further comprises:
positioning the virtual light in the fixed position above the 3D model of the item and directed toward the 3D model of the item, wherein the virtual light comprises a virtual spotlight.

13. The method of claim 11, wherein when the view mode is the stand-alone 3D model view, positioning the virtual light further comprises:
positioning the virtual light in the fixed position in front of the 3D model of the item to direct the virtual light toward the 3D model of the item when the item is designed to be attached to a vertical surface, wherein the virtual light comprises a virtual spotlight.

14. The method of claim 11, wherein when the view mode is stand-alone 3D model view, positioning the virtual light further comprises:
generating an invisible horizontal surface located under the 3D model of the item when the item is placed on a horizontal surface to prevent rendering shadows projected by the virtual light on the horizontal surface, wherein the virtual light comprises a virtual spotlight.

15. The method of claim 11 further comprising:
calculating an outer angle of a cone of the virtual light, wherein the virtual light comprises a virtual spotlight.

16. The method of claim 15, wherein calculating the outer angle of the cone of the virtual light comprises:
determining a light intensity attenuated between zero degrees and the outer angle of the cone of the virtual spotlight.

17. The method of claim 11 further comprising:
setting a light intensity of the virtual light to a predetermined value.

18. The method of claim 11 further comprising:
setting a color temperature of the virtual light to a predetermined value.

19. The method of claim 11 further comprising:
setting a light intensity of the virtual light based on a distance of the virtual light from the 3D model of the item.

20. The method of claim 11 further comprising:
setting a light intensity of the virtual light to a first predetermined value; and
setting a color temperature of the virtual light to a second predetermined value.
